(19) United States
(12) Patent Application Publication
(10) Pub. No.: US 2003/0165718 A1
(43) Pub. Date: Sep. 4, 2003

(54) Method for forming a bonding pad in a TFT array process for a reflective LCD and bonding pad formed by the method

(76) Inventors: Hung-Heui Hsu, Hsinchu (TW); Wen-Jian Lin, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/373,759

(22) Filed: Feb. 27, 2003

(30) Foreign Application Priority Data
Mar. 1, 2002 (TW) 091104111

(51) Int. Cl. B05D 5/12; B05D 1/36; B32B 15/04

(52) U.S. Cl. 428/701; 427/58; 427/404; 428/469; 428/195.1

(57) ABSTRACT

Disclosed is a method for forming a bonding pad in a TFT array process for a reflective LCD and the bonding pad formed by the method, in which an ITO is formed on the first or second metal layer directly during the fabrication of the TFT structure for the reflective LCD to thereby obtain the bonding pad directly after etching the contact window for the scan bonding pad or data bonding pad, and thus an ITO mask process for bonding pad is saved and the LCD process is simplified.

### FIELD OF THE INVENTION

The present invention relates generally to a method for manufacture of liquid crystal display (LCD), and more particularly to a method for forming a bonding pad in a thin film transistor (TFT) array process for a reflective LCD and the bonding pad formed by the method.

### BACKGROUND OF THE INVENTION

Indium tin oxide (ITO) has been widely used in manufacture of TFT-LCDs for their transparent pixel electrodes and the contact layers of the TFT plate to be attached with external driver integrated circuits (ICs). Due to its low contact resistance and good reliability of life test, ITO is almost the best material for bonding pads. However, it is not a must be to use ITO for pixel electrodes in reflective LCDs, since the reflective metal layer already replaces it. Even though, it still needs an additional ITO photo mask procedure to make the bonding pads in the fabrication process for reflective LCDs.

In a typical process for manufacture of a reflective LCD, as shown in FIG. 1, there are included first metal layer step 11, amorphous silicon (a-Si) step 12 and second metal layer step 13 to fabricate TFTs structure, and the following steps comprise bumping 14 for scattering film to increase light efficiency, etching 15 for contact windows, ITO deposition 16 for bonding pads, and reflector formation 17. Obviously, even though ITO is not used for pixel electrodes in a reflective LCDs, it is still necessary an additional ITO photo mask procedure to form bonding pads in the TFT array process, resulting in complicated and time consuming process and low throughput production. Moreover, during the contact windows etching process, the surfaces of the first and second metal layers connected to the gate and source/drain respectively are easily to be contaminated by residual chemicals and, as a result, the ITO subsequently deposited on the surfaces of the metal layers has poor adhesion, low conductivity and large contact resistance, such that the signal transmission efficiency thereof is reduced and the LCD has poor performance.

### SUMMARY OF THE INVENTION

An object of the present invention is to provide a simplified method for LCD manufacture. According to the present invention, a TFT array process for a reflective LCD comprises deposition of an ITO following the first and/or second metal layers to form a TFT array structure. Therefore, after contact windows etching, scan bonding pads and/or data bonding pads are obtained directly, and no more photo mask procedure is needed for ITO bonding pads, such that the LCD process is simplified.

### BRIEF DESCRIPTION OF THE DRAWINGS

The above and other objects, features and advantages of the present invention will become apparent to those skilled in the art upon consideration of the following description of the preferred embodiments of the present invention taken in conjunction with the accompanying drawings, in which:

FIG. 1 shows a conventional process for manufacturing a reflective LCD;

FIG. 2 shows the first embodiment process according to the present invention;

FIGS. 3A-3C are schematic illustration of the structures for a TFT structure, scan bonding pad and data bonding pad, respectively, manufactured by the process shown in FIG. 2;

FIG. 4 shows the second embodiment process according to the present invention;

FIGS. 5A-5C are schematic illustration of the structures for a TFT structure, scan bonding pad and data bonding pad, respectively, manufactured by the process shown in FIG. 4;

FIG. 6 shows the third embodiment process according to the present invention; and

FIGS. 7A-7C are schematic illustration of the structures for a TFT structure, scan bonding pad and data bonding pad, respectively, manufactured by the process shown in FIG. 6.

### DETAILED DESCRIPTION OF THE INVENTION

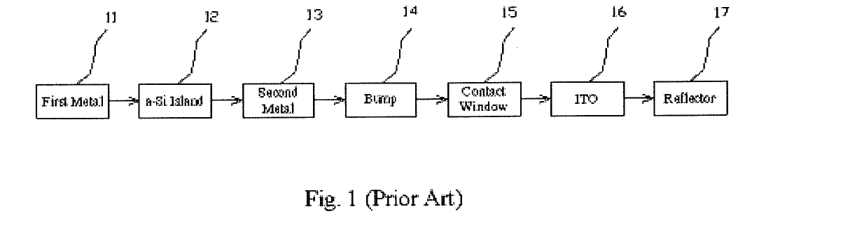

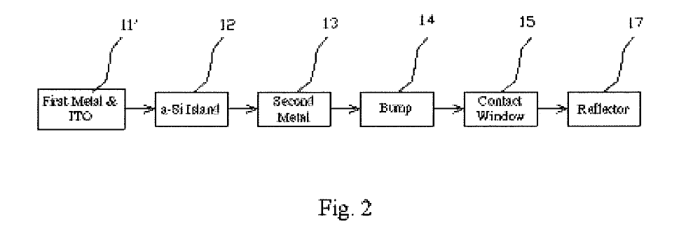

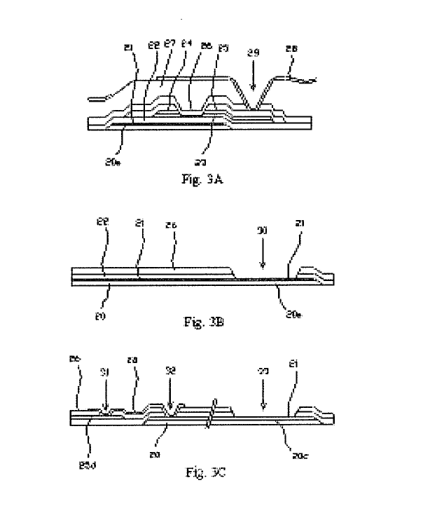

According to the present invention, a first embodiment process for manufacture of an LCD is shown in FIG. 2, in which step 11′ includes deposition of an ITO on a first metal later after the metal layer is formed. The first metal layer comprises a gate for a TFT structure and a scan bonding pad and a data bonding pad that will be formed in future. The following steps 12 to 17 are the same as the prior art process shown in FIG. 1, only without the ITO deposition 16 of FIG. 1 and thus saving one photo mask procedure and improving the adhesion between the ITO and the first metal layer. The ITO formed on the first metal layer can be used as the contact layer of bonding pad directly after the contact window etching. FIGS. 3A-3C are cross-sectional views of structures manufactured by the process shown in FIG. 2, in which FIG. 3A is the schematic illustration of a TFT structure, FIG. 3B is the schematic illustration of a scan bonding pad structure, and FIG. 3C is the schematic illustration of a data bonding pad structure. In FIG. 3A, the TFT structure is similar to that in prior art, of which a gate 20a is provided by a first metal layer 20 on which an ITO 21 is deposited, a gate insulator 22 covered on the gate 20a with an a-Si island 23 formed thereon, and N+ regions 24 formed on the surface of the a-Si island 23 for contacts of source/drain that are provided by a second metal layer 25. The structure is further covered by an insulator 26 and a passivation 27 that can be used for scattering film, and a reflector 28 is formed thereon with a connection to the second metal layer 25 in a contact window 29. In FIG. 3B, a scan bonding pad 20b is provided by the first metal layer 20, and there is already an ITO 21 on the scan bonding pad 20b after a contact window 30 is formed. In FIG. 3C, a data bonding pad 20c is also provided by the first metal layer 20, which is different from the traditional LCD, and a data line 25d is still provided by the second metal layer 25 with the reflector 28 to connect it to the data bonding pad 20c. The reflector 28 is connected to the data line 25d in the contact window 31 and to the data bonding pad 20c in the contact window 32.

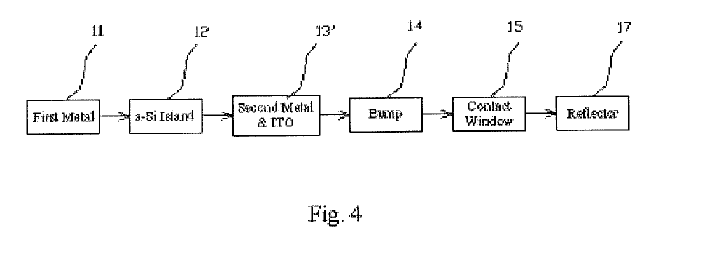

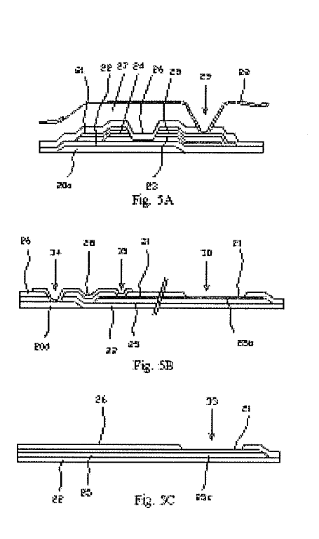

A second embodiment process for manufacture of an LCD according to the present invention is further shown in FIG. 4, which is similar to that shown in FIG. 2, only that step 11 for the first metal layer is the same as the conventional one as shown in FIG. 1 and step 13′ includes deposition of an ITO on a second metal later after the metal layer is formed. Moreover, the second metal layer comprises source/drain for a TFT structure and a scan bonding pad and a data bonding pad that will be formed in future. Likewise, this process needs not the step 16 for ITO deposition of FIG. 1 so as to save one photo mask procedure, and the adhesion between the ITO and second metal layer is improved. The ITO formed on the second metal layer can be used as the contact layer of bonding pad directly after the contact window etching. FIGS. 5A-5C are cross-sectional views of structures manufactured by the process shown in FIG. 4, in which FIG. 5A is the schematic illustration of a TFT structure, FIG. 5B is the schematic illustration of a scan bonding pad structure, and FIG. 5C is the schematic illustration of a data bonding pad structure. In FIG. 5A, the TFT structure is similar to that shown in FIG. 3A, only that no ITO is deposited on the first metal layer 20, and so the gate 20a, instead, an ITO 21 is deposited on the second metal layer 25. The remaining portion of the structure in FIG. 5A is same as that in FIG. 3A. In FIG. 5B, a scan bonding pad 20b is provided by the second metal layer 25, which is different from the traditional LCD, and a scan line 20d is still provided by the first metal layer 20 with the reflector 28 to connect it to the scan bonding pad 25b. The reflector 28 is connected to the scan line 20d in the contact window 34 and to the scan bonding pad 25b in the contact window 35. In FIG. 5C, a data bonding pad 25c is also provided by the second metal layer 25, and there is already an ITO 21 on the data bonding pad 25c after a contact window 33 is formed.

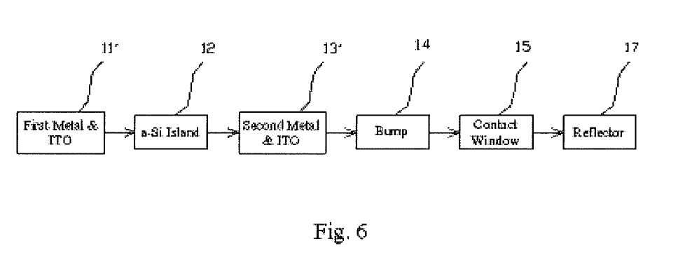

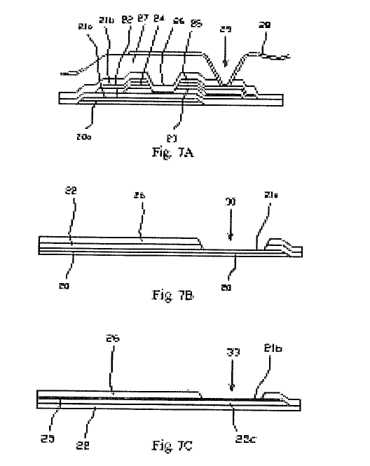

FIG. 6 shows the third embodiment process for manufacture of an LCD according to the present invention, whose steps 11′ and 13′ include depositing an ITO on the first and second metal layers after these two metal layers are formed, respectively. The first metal layer comprises a gate for a TFT structure and a scan bonding pad that will be formed in future, and the second metal layer comprises source/drain for the TFT structure and a data bonding pad that will be formed in future. The other steps are same as those in conventional process. Likewise, this process needs not to deposite ITO for bonding pads after etching the contact windows, thereby saving a photo mask procedure and improving the adhesion of the deposited ITO to the first and second metal layers. The ITO formed on the first metal layer can be used as the contact layer of the scan bonding pad directly after the contact window etching, and the ITO formed on the second metal layer can be used as the contact layer of the data bonding pad directly after the contact window etching. FIGS. 7A-7C are cross-sectional views of structures manufactured by the process shown in FIG. 6, in which FIG. 7A is the schematic illustration of a TFT structure, FIG. 7B is the schematic illustration of a scan bonding pad structure, and FIG. 7C is the schematic illustration of a data bonding pad structure. In FIG. 7A, the TFT structure is similar to a conventional one, only that on the gate 20a is deposited with an ITO 21a, and on the second metal layer 25 is deposited with an ITO 21b. Different from a conventional LCD, in FIG. 7B, a scan bonding pad 20b is provided by the first metal layer 20, and there is already the ITO 21a on the scan bonding pad 20b after a contact window 30 is formed. Similarly, in FIG. 7C, a data bonding pad 25c is provided by the second metal layer 25, and there is already the ITO 21b on the data bonding pad 25c after a contact window 33 is formed.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A method for forming a bonding pad in a TFT array process for a reflective LCD, said method comprising the steps of:
forming a first metal layer;
depositing an ITO on said first metal layer;
forming a gate, a scan bonding pad and a data bonding pad with said first metal layer;
fabricating a TFT structure;
forming a second metal layer;
forming source/drain and a data line with said second metal layer; and
forming a conductor for connecting said data bonding pad to said data line.

2. A method according to claim 1, further comprising forming a reflector.

3. A method for forming a bonding pad in a TFT array process for a reflective LCD, said method comprising the steps of:
forming a first metal layer;
forming a gate and a scan line with said first metal layer;
fabricating a TFT structure;
forming a second metal layer;
depositing an ITO on said second metal layer;
forming source/drain, a scan bonding pad and a data bonding pad with said second metal layer; and
forming a conductor for connecting said scan bonding pad to said scan line.

4. A method according to claim 3, further comprising forming a reflector.

5. A method for forming a bonding pad in a TFT array process for a reflective LCD, said method comprising the steps of:
forming a first metal layer;
depositing a first ITO on said first metal layer;
forming a gate and a scan line with said first metal layer;
fabricating a TFT structure;
forming a second metal layer;
depositing a second ITO on said second metal layer;
forming source/drain and a data line with said second metal layer; and
forming contact windows for a data bonding pad and a scan bonding pad.

6. A method according to claim 5, further comprising forming a reflector.

7. A method according to claim 5, further comprising the steps of:
forming said data bonding pad with said first metal layer;
forming said scan bonding pad with said second metal layer;
forming a first conductor for connecting said scan bonding pad to said scan line; and
forming a second conductor for connecting said data bonding pad to said data line.

8. A bonding pad arrangement for a reflective LCD, comprising:
a first metal layer including a gate formed therewith;
an ITO on said first metal layer;
a second metal layer including source/drain formed therewith;
a data line connected to said source;
a scan bonding pad formed from said first metal layer;
a data bonding pad formed from said first metal layer; and
means for connecting said data bonding pad to said data line.

9. A bonding pad arrangement for a reflective LCD, comprising:
a first metal layer including a gate formed therewith;
a second metal layer including source/drain formed therewith;
an ITO on said second metal layer;
a scan line connected to said gate;
a scan bonding pad formed from said second metal layer;
a data bonding pad formed from said second metal layer; and
means for connecting said scan bonding pad to said scan line.

10. A bonding pad arrangement for a reflective LCD, comprising:
a first metal layer including a gate formed therewith;
a first ITO on said first metal layer;
a second metal layer including source/drain formed therewith;
a second ITO on said second metal layer;
a first bonding pad formed from said first metal layer; and
a second bonding pad formed from said second metal layer.

11. A bonding pad arrangement according to claim 10, wherein said first and second bonding pads are a scan bonding pad and a data bonding pad, respectively.

12. A bonding pad arrangement according to claim 10, further comprising:
a scan line connected to said gate;
a data line connected to said source;
means for connecting said second bonding pad to said scan line; and
means for connecting said first bonding pad to said data line.
